(19) United States
(12) Patent Application Publication
(10) Pub. No.: US 2018/0095273 A1
(43) Pub. Date: Apr. 5, 2018

(54) DISPLAY APPARATUS AND METHOD OF DESIGNING THE DISPLAY APPARATUS

(71) Applicant: SAMSUNG ELECTRONICS CO., LTD., Suwon-si (KR)

(72) Inventors: Young Ju JEONG, Yongin-si (KR); Hyunjoon KIM, Seoul (KR); Bongsu SHIN, Seoul (KR); Dongkyung NAM, Yongin-si (KR); Jinho LEE, Suwon-si (KR); Yoonsun CHOI, Yongin-si (KR)

(73) Assignee: SAMSUNG ELECTRONICS CO., LTD., Suwon-si (KR)

(21) Appl. No.: 15/463,469

(22) Filed: Mar. 20, 2017

(30) Foreign Application Priority Data
Oct. 5, 2016 (KR) 10-2016-0128299

(51) Int. Cl. G02B 27/00; G02B 27/22

(52) U.S. Cl. CPC G02B 27/0012; G02B 27/2214

(57) ABSTRACT

A display apparatus and a method of designing the display apparatus are provided. The display apparatus may include a display panel including a plurality of pixels to which a plurality of pieces of output information for outputting a three-dimensional image is allocated according to a sequence, and a grating layer including a plurality of grating elements configured to transfer, to the plurality of pixels, directional light according to the sequence, wherein the sequence is determined so that a distance between pieces of output information allocated to neighboring pixels among the plurality of pixels corresponds to a relatively prime number of a number of the plurality of pieces of output information allocated to the plurality of pixels.

### CROSS-REFERENCE TO RELATED APPLICATION

This application claims priority from Korean Patent Application No. 10-2016-0128299, filed on Oct. 5, 2016, in the Korean Intellectual Property Office, the disclosure of which is incorporated herein by reference in its entirety.

### BACKGROUND

### 1. Field

Apparatuses and methods consistent with example embodiments relate to a display apparatus and a method of designing the display apparatus.

### 2. Description of the Related Art

To recognize a stereoscopic image, different images may need to be viewed by both eyes of a user. A method of displaying the different images to the eyes of the user may include, for example, a glass-type method of obtaining a desired image through filtering using polarization-based division, time division, or wavelength division of varying a wavelength of a primary color, and a glassless-type method of displaying each image in a certain space using a parallax barrier, a lenticular lens, or a directional backlight unit.

Recently, a glassless-type method using a diffraction grating has been suggested.

### SUMMARY

Example embodiments may address at least the above problems and/or disadvantages and other disadvantages not described above. Also, the example embodiments are not required to overcome the disadvantages described above, and an example embodiment may not overcome any of the problems described above.

According to an aspect of one or more example embodiments, there is provided a display apparatus including a display panel including a plurality of pixels to which a plurality of pieces of output information for outputting a three-dimensional (3D) image is allocated according to a sequence, and a grating layer including a plurality of grating elements configured to transfer, to the plurality of pixels, directional light according to the sequence. The sequence may be determined so that a distance between pieces of output information allocated to neighboring pixels among the plurality of pixels corresponds to a relatively prime number of a number of the plurality of pieces of output information allocated to the plurality of pixels.

The plurality of grating elements may be arranged in the grating layer so that light refracted while penetrating through an optical film disposed between the display panel and the grating layer has directivity according to the sequence in the grating layer.

A width of each of the plurality of grating elements may be a minimum distance between neighboring grating elements in the grating layer.

A width of each of the plurality of grating elements may be a maximum value in a range in which the plurality of grating elements in the grating layer do not overlap each other.

In response to a plurality of relatively prime numbers of the number of the pieces of output information existing, the sequence may be determined by determining a sequence corresponding to each of the relatively prime numbers based on a corresponding relatively prime number, verifying minimum distances between neighboring grating elements among a plurality of grating elements corresponding to each of the sequences, and selecting a sequence corresponding to a minimum distance having a greatest value among the verified minimum distances.

A location of each of the plurality of grating elements may be determined based on a corresponding sequence, and a minimum distance between neighboring grating elements among the plurality of grating elements may be determined based on the location of each of the plurality of grating elements determined according to a corresponding sequence.

The 3D image may include a multiview image represented by multiple viewpoints, and the output information may include a viewpoint to be represented in a corresponding among the multiple viewpoints represented in the multiview image.

The 3D image may include an integral image embodying the 3D image by integrating elemental images including 3D information of a target object into the 3D image, and the output information may include a direction angle at which light is to be radiated from a corresponding pixel among a plurality of direction angles represented in the integral image.

The sequence may be determined so that a distance between direction angles allocated to the neighboring pixels among the plurality of pixels is determined by a relatively prime number of a number of the direction angles represented in the integral image and a minimum angle difference among the direction angles represented in the integral image.

According to another aspect of one or more example embodiments, there is provided a method of designing a display apparatus including a display panel and a grating layer, the method including determining a relatively prime number of a number of pieces of output information to output a 3D image through a plurality of pixels included in the display panel, determining a sequence in which the output information is to be allocated to the plurality of pixels based on the relatively prime number, determining a location of each of a plurality of grating elements included in the grating layer to transfer, to the plurality of pixels, directional light according to the sequence, verifying a minimum distance between neighboring grating elements among the plurality of grating elements, and in response to a plurality of relatively prime numbers of the number of the pieces of output information existing, allocating the output information to the plurality of pixels based on a selected sequence corresponding to a minimum distance having a greatest value among the verified minimum distances corresponding respectively to the plurality of relatively prime numbers.

The determining of the location of each of the plurality of grating elements may include determining the location of each of the plurality of grating elements so that light refracted while penetrating through an optical film disposed between the display panel and the grating layer has directivity corresponding to the sequence in the plurality of pixels.

A width of each of the plurality of grating elements corresponding to the selected sequence may be determined as a minimum distance between the neighboring grating elements among the plurality of grating elements arranged based on the selected sequence.

A width of each of a plurality of grating elements corresponding to the selected sequence may be determined as a greatest value in a range in which the plurality of grating elements arranged based on the selected sequence do not overlap each other.

### BRIEF DESCRIPTION OF THE DRAWINGS

The above and/or other aspects will be more apparent and more readily appreciated from the following description of example embodiments, taken in conjunction with the accompanying drawings of which:

FIG. 1 is a diagram illustrating a display apparatus according to an example embodiment;

FIG. 2 is a flowchart illustrating a method of designing a display apparatus according to an example embodiment;

FIG. 3 is a diagram illustrating a method of calculating a location of each of grating elements according to an example embodiment;

FIG. 4 is a diagram illustrating a method of verifying a minimum distance between grating elements according to an example embodiment;

FIG. 5 is a diagram illustrating a width of a grating element according to an example embodiment;

FIG. 6 is a flowchart illustrating a method of selecting an direction angle sequence of an integral image according to an example embodiment; and

FIG. 7 is a flowchart illustrating a method of selecting a viewpoint sequence of a multiview image according to an example embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions may not be described in detail because they would obscure the description with unnecessary detail.

The terminology used herein is for the purpose of describing the example embodiments only and is not intended to be limiting of the disclosure. As used herein, the singular forms “a,” “an,” and “the” are intended to include the plural forms as well, unless the context clearly indicates otherwise. It will be further understood that the terms “include,” “comprise” and/or “have,” when used in this disclosure, specify the presence of stated features, integers, steps, operations, elements, components, or combinations thereof, but do not preclude the presence or addition of one or more other features, integers, steps, operations, elements, components, and/or groups thereof. In addition, the terms such as “unit,” “-er (-or),” and “module” described in the specification refer to an element for performing at least one function or operation, and may be implemented in hardware, software, or the combination of hardware and software.

Terms such as first, second, A, B, (a), (b), and the like may be used herein to describe components. Each of these terminologies is not used to define an essence, order or sequence of a corresponding component but used to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Example embodiments to be described hereinafter may be applicable to a display device or used to design the display device. The example embodiments may be used to a three-dimensional (3D) display using non-geometrical optics in addition to a parallax barrier or a lenticular lens.

The example embodiments may be embodied in various forms of display apparatuses, for example, a personal computer (PC), a laptop computer, a tablet PC, a smartphone, a television (TV), a smart home appliance, a kiosk, and a wearable device. For example, the example embodiments may be applicable to a display apparatus, for example, a mobile device and a smart home appliance. In addition, the example embodiments may be applicable to designing the display apparatus. Hereinafter, example embodiments are described in detail with reference to the accompanying drawings. Like reference numerals in the drawings denote like elements, and a known function or configuration will be omitted herein.

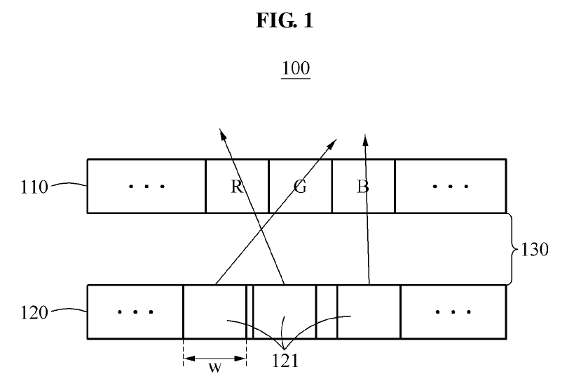

FIG. 1 is a diagram illustrating a display apparatus 100 according to an example embodiment.

Referring to FIG. 1, the display apparatus 100 includes a display panel 110 and a grating layer 120. In addition, the display apparatus 100 further includes an optical film 130.

The display apparatus 100 may provide a 3D image to a viewer by displaying different images to a left eye and a right eye of the viewer. The viewer may then experience a 3D effect by a binocular disparity. The display apparatus 100 may provide the 3D image to the viewer by outputting the 3D image to the display panel 110 using directional light transferred from the grating layer 120.

The display panel 110 may include a plurality of pixels, and output the 3D image through the pixels. To the pixels, output information may be allocated to output the 3D image. A glassless-type 3D image will be described hereinafter before describing the output information.

The glassless-type 3D image may include, for example, an integral image and a multiview image.

An integral imaging method may store, in a form of an elemental image, 3D information of a target object using a lens array including a plurality of elemental lens, and embody a 3D image by integrating stored elemental images through the lens array. When embodying the 3D image through the integral imaging method, a plurality of pixels included in a display panel may output an image corresponding to a direction angle allocated to a corresponding pixel. The direction angle refers to an angle at which light is to be radiated from a pixel, and a 3D image may be embodied by radiating an image output to the pixel at a predetermined direction angle.

A multiview imaging method may embody a 3D image by providing, to both eyes of a viewer, images corresponding to different two viewpoints among a plurality of viewpoints. For example, the viewer may view an image corresponding to a first viewpoint with a left eye, and view an image corresponding to a second viewpoint with a right eye, and thus may experience a 3D effect from the 3D image. The pixels included in the display panel 110 may output an image of a viewpoint allocated to a corresponding pixel to embody such a 3D image.

A direction angle in the integral imaging method and a viewpoint in the multiview imaging method may indicate the output information to output the 3D image from the pixels. That is, the output information may be allocated to the pixels included in the display panel 110, and the pixels may output the 3D image based on the output information allocated to the pixels, and thus the viewer may view the 3D image.

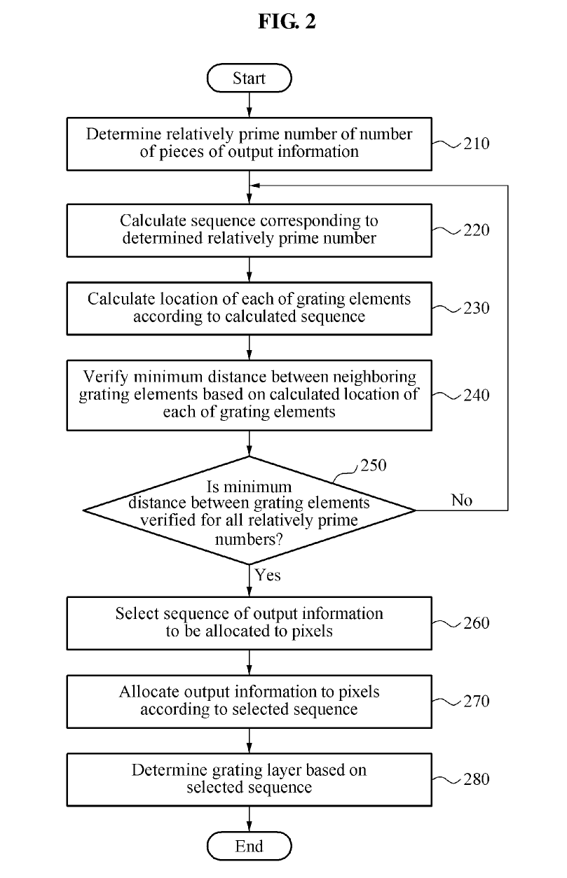

The output information may be allocated to the pixels in a predetermined sequence. A sequence in which the output information is allocated to the pixels may be determined to improve a quality of the 3D image by equally distributing light radiated from the display panel 110. A method of determining a sequence will be described with reference to FIG. 2.

To embody a glassless-type 3D image, different images output from the display apparatus 100 may need to be provided to both eyes of a viewer, and thus directional light may need to be provided.

The grating layer 120 includes a plurality of grating elements 121 configured to transfer directional light to the display panel 110. The grating elements 121 may assign directivity to light provided from a backlight unit, and transfer the light to the display panel 110.

The grating elements 121 may be diffraction gratings each including two substances having different refractive indices, and may transfer directional light by controlling a direction in which the light is to be radiated through the two substances.

The grating elements 121 may transfer, to the pixels, the directional light according to the sequence. For example, each of the grating elements 121 may transfer directional light to a corresponding pixel based on output information allocated to the corresponding pixel according to the sequence. Here, the number of the grating elements 121 may correspond to the number of pixels receiving the directional light.

Referring to FIG. 1, three subpixels, for example, red (R), green (G), and blue (B), may be included in the display panel 110, and output information corresponding to each of the three subpixels, for example, an direction angle, may be allocated to a corresponding subpixel. Here, directional light corresponding to the output information allocated to a subpixel may be transferred to the pixel through the grating elements 121. Based on the output information allocated to the subpixels, an arrangement of the grating elements 121 configured to transfer the directional light to the corresponding subpixels may be reversed. For example, although the subpixels R, G, and B in the display panel 110 are arranged in order starting from the subpixel R, and to the subpixel G and the subpixel B, the grating elements 121 may not be arranged in such an order, and a grating element configured to transfer directional light to the subpixel G may be arranged in a left side of a grating element configured to transfer directional light to the subpixel R, as illustrated.

The grating elements 121 may have a preset width (w). As the width of each of the grating elements 121 increases, a greater amount of light may be transferred to the display panel 110. Thus, designing the width of each of the grating elements 121 to be greater may prevent degradation of brightness, or an increase in diffraction or crosstalk that may occur in the grating layer 120. However, when the width of each of the grating elements 121 increases and accordingly neighboring grating elements overlap one another, light to be radiated from the overlapping grating elements may split into two directions, and thus the neighboring grating elements may need to be designed not to overlap one another.

At least one optical film 130 may be disposed between the display panel 110 and the grating layer 120. The optical film 130 refers to a film used to adjust a light efficiency or directivity of light provided from the backlight unit and may include, for example, a brightness enhancement film (BEF) and a dual brightness enhancement film (DBEF).

The optical film 130 may refract directional light penetrating the optical film 130. For example, the optical film 130 may have a refractive index, and refract the directional light based on the refractive index and Snell's law.

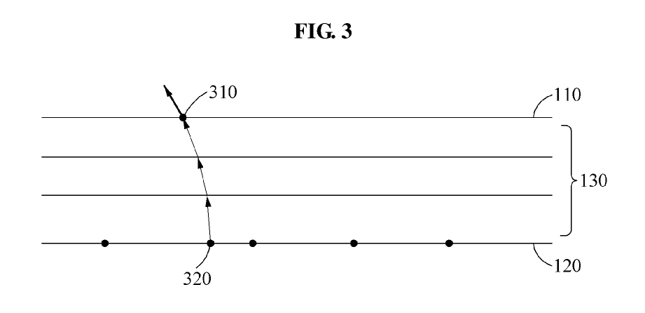

Although, for convenience of description, FIG. 1 illustrates directional light transferred from the grating layer 120 to the display panel 110 not being refracted by the optical film 130, how the directional light transferred to the display panel 110 is refracted by the optical film 130 will be described with reference to FIG. 3.

FIG. 2 is a flowchart illustrating a method of designing a display apparatus according to an example embodiment.

The method of designing a display apparatus may be performed by a processor included in a designing apparatus configured to determine a design parameter for the display apparatus. The design parameter refers to a parameter for at least one of a display panel or a grating layer included in the display apparatus and may include, for example, output information allocated to a plurality of pixels included in the display panel, a sequence of the output information, an arrangement of grating elements included in the grating layer, and a width of each of the grating elements. The display apparatus 100 illustrated in FIG. 1 may be an apparatus designed according to a design parameter determined by the designing apparatus.

Referring to FIG. 2, in operation 210, the designing apparatus determines a relatively prime number of a number of pieces of output information allocated to a plurality of pixels. The output information refers to information used to output a 3D image and may include, for example, a direction angle of an integral image and a viewpoint of a multiview image.

For example, when eight pieces of output information are allocated to the pixels, numbers 3, 5, and 7 are determined to be relatively prime to the number 8 of the pieces of output information.

In operation 220, the designing apparatus calculates a sequence corresponding to the determined relatively prime number based on the relatively prime number. The sequence refers to a sequence in which output information is to be allocated to the pixels and may include, for example, a sequence in which output information is to be allocated to pixels included in a same row among the pixels arranged on a plurality of rows and a plurality of columns.

The designing apparatus may determine the sequence to allow a distance between pieces of output information allocated to neighboring pixels to correspond to the relatively prime number of the number of the pieces of output information. The distance between the pieces of output information may indicate a difference between pieces of output information of targets to be compared. For example, when 1 and 3 are allocated as output information to neighboring pixels, a distance between the pieces of output information may be 2, which is a difference between 1 and 3.

The sequence may be calculated based on Equation 1 below.

Sᵢ(x)=mod((x−1)*nᵢ,N)+1 [Equation 1]

In Equation 1, Sᵢ(x) denotes an i-th sequence, in which x denotes an element included in the sequence and includes a constant from 1 to N, nᵢ denotes a relatively prime number corresponding to the i-th sequence, N denotes the number of pieces of output information to be allocated to a plurality of pixels, and mod( ) denotes a mod function.

For example, in a case of 3 that is relatively prime to 8, a first sequence may be calculated to be [1, 4, 7, 2, 5, 8, 3, 6]. Here, numbers included in the sequence indicate identification numbers for the pieces of output information. For example, 1 may indicate first output information, for example, a first direction angle of an integral image and a first viewpoint of a multiview image. Similarly, 2 may indicate second output information, for example, a second direction angle of the integral image and a second viewpoint of the multiview image. The foregoing may be applicable identically to the remaining numbers included in the sequence.

When output information according to the first sequence is allocated to pixels neighboring one another in a horizontal direction, first output information may be allocated to a first pixel, fourth output information to a second pixel, seventh output information to a third pixel, and second output information to a fourth pixel, and also corresponding output information may be allocated to the remaining pixels in the same manner as described in the foregoing.

Similarly, in a case of 5 and 7 that are relatively prime to 8, a second sequence may be calculated to be [1, 6, 3, 8, 5, 2, 7, 4], and a third sequence may be calculated to be [1, 8, 7, 6, 5, 4, 3, 2]. As described above, when the number of pieces of output information is eight, three sequences may be calculated.

Calculating a sequence using a relatively prime number may prevent a simple increment of output information as in [1, 2, 3, 4, 5, 6, 7, 8], and enable calculation of a sequence in an equivalently incremental pattern in which pieces of output information have a regular distance and may be mixed.

In operation 230, the designing apparatus calculates a location of each of grating elements based on the calculated sequence. The designing apparatus may calculate a location of each of a plurality of grating elements included in a grating layer to allow directional light according to the sequence to be transferred to the plurality of pixels. For example, the grating elements may be arranged in the grating layer to allow light refracted while penetrating through an optical film disposed between the display panel and the grating layer to have directivity in the pixels according to the sequence. The location of each of the grating elements arranged in the grating layer may be determined based on a refractive index of the optical film and Snell's law. A method of determining a location of each of a plurality of grating elements based on a refractive index of an optical film and Snell's law will be described in more detail with reference to FIG. 3.

In operation 240, the designing apparatus verifies a minimum distance between neighboring grating elements based on the calculated locations of the grating elements. Based on the locations of the grating elements calculated in operation 230, the designing apparatus may verify a distance between neighboring grating elements and the minimum distance among the verified distances.

For example, based on the locations of the grating elements calculated in operation 230, a minimum distance may be verified for each sequence. For example, a minimum distance a, a minimum distance b, and a minimum distance c may be verified for the first sequence, the second sequence, and the third sequence, respectively.

In operation 250, the designing apparatus determines whether the minimum distance between neighboring grating elements is verified for all the relatively prime numbers. When the minimum distance between neighboring grating elements is not verified for all the relatively prime numbers, the designing apparatus may perform operations 220 through 240, repetitively, until the minimum distance between neighboring grating elements is verified for all the relatively prime numbers.

In operation 260, when the minimum distance between neighboring grating elements is verified for all the relatively prime numbers, the designing apparatus selects a sequence of the output information to be allocated to the plurality of pixels based on the minimum distance verified in operation 250. The designing apparatus may select a sequence corresponding to the minimum distance having a greatest value among the verified minimum distances.

For example, when the minimum distance b is the greatest value among the minimum distances a, b, and c verified in operation 240, the second sequence corresponding to the minimum distance b may be selected.

In operation 270, the designing apparatus allocates the output information to the plurality of pixels based on the selected sequence. For example, the output information may be allocated to the plurality of pixels based on the second sequence selected in operation 260, for example, [1, 6, 3, 8, 5, 2, 7, 4].

In operation 280, the designing apparatus determines, or designs, the grating layer based on the selected sequence. The designing apparatus may determine a location and a width of each of the grating elements based on the selected sequence.

For example, the location of each of the grating elements may be determined to allow directional light according to the selected sequence to be transferred to the plurality of pixels. In addition, the width of each of the grating elements may be determined to be the minimum distance between neighboring grating elements among the plurality of grating elements arranged based on the selected sequence.

Thus, by determining the width of each of the grating elements based on the selected sequence, a distance between pieces of output information allocated to neighboring pixels may correspond to a relatively prime number of the number of the pieces of output information, and the width of each of the grating elements may be maximized.

FIG. 3 is a diagram illustrating a method of calculating a location of each of grating elements according to an example embodiment.

Referring to FIG. 3, a display panel 110, a grating layer 120, and an optical film 130 are illustrated to explain the method of calculating a location of each of grating elements to allow directional light according to a sequence to be transferred to a plurality of pixels. Hereinafter, the method of calculating a location of each grating element will be described based on calculation of a location of a grating element 320 configured to transfer directional light to a pixel 310 included in the display panel 110.

Referring to FIG. 3, output information may be allocated to the pixel 310 based on a sequence. For example, a direction angle indicated by a bold arrow may be allocated to the pixel 310.

The grating element 320 may be arranged in the grating layer 120 to transfer the directional light to the pixel 310 based on the output information allocated to the pixel 310 based on the sequence.

The directional light radiated from the grating element 320 may be refracted while penetrating through the optical film 130 disposed between the display panel 110 and the grating layer 120. For example, as illustrated in FIG. 3, the optical film 130 may include two optical films.

In such an example, the directional light radiated from the grating layer 120 may be refracted based on a refractive index of the optical film 130. For example, the directional light may be refracted while penetrating through the optical film 130 based on the refractive index of the optical film 130 and Snell's law. Based on the refraction of the directional light, the location of the grating element 320 to allow the directional light based on the output information allocated to the pixel 310 to be transferred to the pixel 310 may be calculated.

Although the two optical films are illustrated as the optical film 130 in FIG. 3, the number of optical films is provided as an illustrative example only for convenience of description, and at least one optical film may be present or any optical films may not be present. In a case that an optical film is not present between the display panel 110 and the grating layer 120, such refraction of directional light while penetrating through the optical film may not be considered.

Although, for convenience of description, the calculation of the location of the grating element 320 configured to transfer the directional light to the pixel 310 is described with reference to FIG. 3 as an example of the method of calculating a location of each of grating elements, the described method may be applicable identically to remaining grating elements included in the grating layer 120, and a more detailed and repeated description will thus be omitted here for brevity.

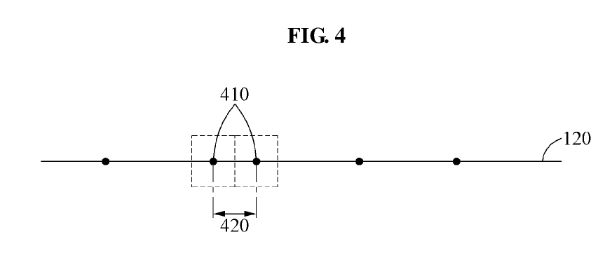

FIG. 4 is a diagram illustrating a method of verifying a minimum distance between grating elements according to an example embodiment.

Referring to FIG. 4, a grating layer 120 in which a location of each of grating elements is determined through the method described with reference 3 is illustrated.

Based on respective locations of the grating elements, distances between neighboring grating elements among the grating elements may be identified, and a minimum distance 420 having a minimum value among the identified distances may be identified. That is, a distance between neighboring grating elements 410 may be identified as the minimum distance 420.

In such a case, the minimum distance 420 may be determined to be a width of each of the grating elements. Determining the minimum distance 420 to be the width of each of the grating elements may prevent overlapping of neighboring grating elements among the grating elements. In a case that neighboring grating elements overlap one another, light radiated from the overlapping grating elements may be split into two directions, and thus the neighboring grating elements may need to be designed not to overlap one another.

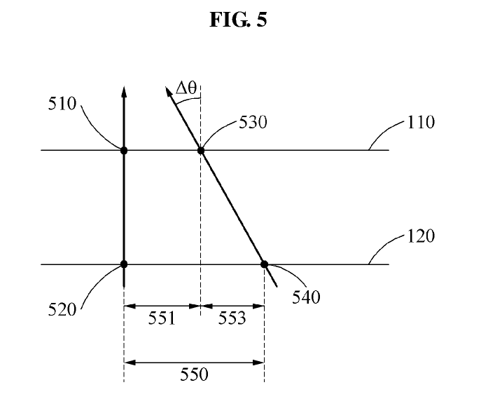

FIG. 5 is a diagram illustrating a width of each of grating elements according to an example embodiment.

Referring to FIG. 5, a display panel 110 and a grating layer 120 are illustrated to explain a width of each of grating elements in the grating layer 120. The display panel 110 includes neighboring pixels, for example, a pixel 510 and a pixel 530, and the grating layer 120 includes neighboring grating elements, for example, a grating element 520 and a grating element 540, to transfer directional light to the neighboring pixels 510 and 530, respectively. For convenience of description, it is assumed that an optical film is not disposed between the display panel 110 and the grating layer 120. However, in a case that the optical film is disposed between the display panel 110 and the grating layer 120, refraction of directional light by the optical film may need to be further considered, and thus the description to be provided hereinafter may also be applicable to such a case.

As illustrated in FIG. 5, output information according to a sequence may be allocated to the neighboring pixels 510 and 530. For example, a direction angle according to the sequence may be allocated to the neighboring pixels 510 and 530, and a difference between the direction angles allocated respectively to the neighboring pixels 510 and 530 may be Δθ.

The neighboring grating elements 520 and 540 may be arranged in the grating layer 120 so that directional light is transferred to the neighboring pixels 510 and 530. In such a case, a distance between the grating elements 520 and 540 may be determined to be a sum of Δg 553+a pixel width 551.

Here, Δg 553 denotes a result obtained by applying Δθ to a value obtained by linearly approximating to a tangent function. The pixel width 551 may be the same as a distance between the neighboring pixels 510 and 530. Thus, a distance 550 between the neighboring grating elements 520 and 540 may be determined to be the sum of Δg 553 and the pixel width 551. Thus, a distance between a plurality of grating elements may be determined to be Δg+a pixel width.

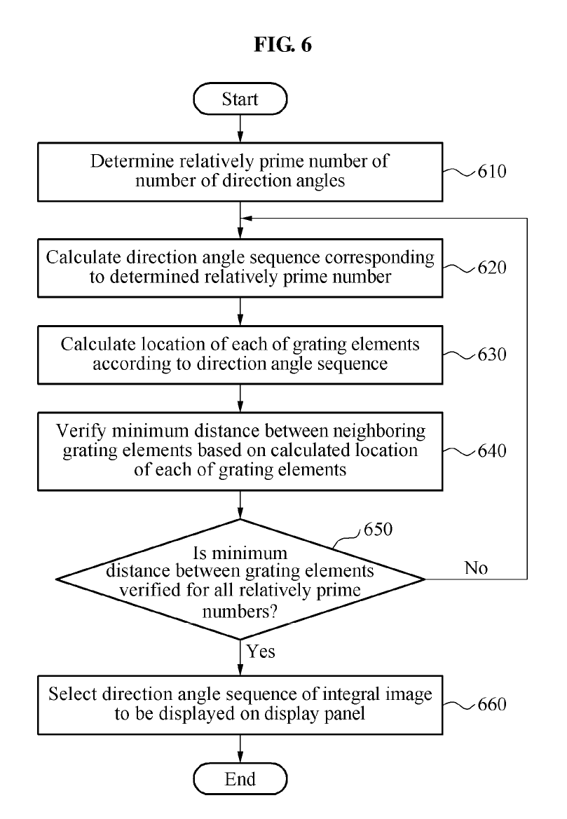

FIG. 6 is a flowchart illustrating a method of selecting a direction angle sequence of an integral image according to an example embodiment.

The method of selecting a direction angle sequence of an integral image may be performed by a processor included in a designing apparatus configured to determine a design parameter for a display apparatus of an integral imaging type.

Referring to FIG. 6, in operation 610, the designing apparatus determines a relatively prime number of a number of direction angles to be displayed on a display panel. In operation 620, the designing apparatus calculates a direction angle sequence corresponding to the relatively prime number. In operation 630, the designing apparatus calculates a location of each of grating elements based on the direction angle sequence. In operation 640, the designing apparatus verifies a minimum distance between the grating elements based on the calculated location of each of the grating elements. In operation 650, the designing apparatus determines whether the minimum distance between the grating elements is verified for all relatively prime numbers. In a case that the minimum distance between neighboring grating elements is not verified for all the relatively prime numbers, the designing apparatus may perform operations 620 through 640 for relatively prime numbers for which such verification is not performed. In operation 660, when the minimum distance between neighboring grating elements is verified for all the relatively prime numbers, the designing apparatus selects a direction angle sequence corresponding to a minimum distance having a greatest value among minimum distances verified in operation 640 to be a direction angle sequence of an integral image to be displayed on the display panel.

When N direction angles to be displayed on the display panel are in a range between an angle a and an angle b, numbers included in a sequence may indicate direction angles as represented in Equation 2 below.

$$A ( x ) = a + \frac{b - a}{N - 1} * ( x - 1 ) \qquad [ Equation 2 ]$$

In Equation 2, A(x) denotes an x-th direction angle.

For example, when eight direction angles are in a range between −70 degrees (°) and +70°, directional angles to be displayed on the display panel may include, for example, −70°, −50°, −30°, −10°, +10°, +30°, +50°, and +70°. That is, a first direction angle may be −70°, a second direction angle may be −50°, and a third direction angle may be −30°. The remaining direction angles may also be determined in the same manner as described in the foregoing.

Thus, when a sequence, for example, [1, 4, 7, 2, 5, 8, 3, 6] is selected in operation 660, direction angles, for example, [−70, −10, +50, −50, +10, +70, −30, +30], may be allocated to the plurality of pixels.

As described, a sequence may be calculated to allow a distance between direction angles allocated to neighboring pixels among a plurality of pixels to be determined by a relatively prime number of the number of direction angles represented in an integral image and by a minimum angle difference between a plurality of direction angles. Here, the minimum angle difference between the direction angles may be 20°.

The details described with reference to FIGS. 1 through 5 may be applicable to the operations described with reference to FIG. 6, and thus a more detailed and repeated description will be omitted here for brevity.

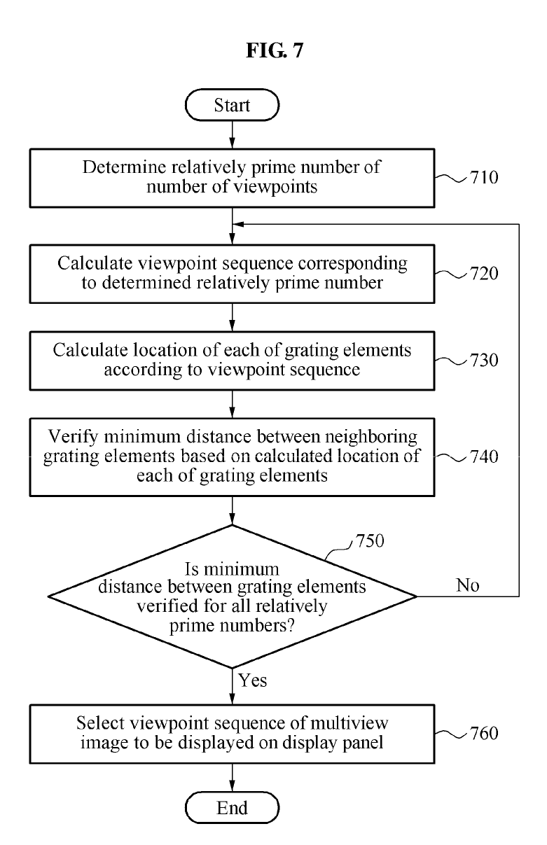

FIG. 7 is a flowchart illustrating a method of selecting a viewpoint sequence of a multiview image according to an example embodiment.

The method of selecting a viewpoint sequence of a multiview image may be performed by a processor included in a designing apparatus configured to determine a design parameter for a display apparatus of a multiview imaging type.

Referring to FIG. 7, in operation 710, the designing apparatus determines a relatively prime number of a number of viewpoints to be displayed on a display panel. In operation 720, the designing apparatus calculates a viewpoint sequence corresponding to the determined relatively prime number. In operation 730, the designing apparatus calculates a location of each of grating elements based on the calculated viewpoint sequence. In operation 740, the designing apparatus verifies a minimum distance between the grating elements based on the location of each of the grating elements. In operation 750, the designing apparatus determines whether the minimum distance between the grating elements is verified for all relatively prime numbers. When a minimum distance between neighboring grating elements is not verified for all the relatively prime numbers, the designing apparatus may perform operations 720 through 740 on a relatively prime number for which a minimum distance is not verified. In operation 760, when the minimum distance between neighboring grating elements is verified for all the relatively prime numbers, the designing apparatus may select a viewpoint sequence corresponding to a minimum distance having a greatest value among minimum distances verified in operation 740 to be a viewpoint sequence of a multiview image to be displayed on the display panel.

The details described with reference to FIGS. 1 through 5 may be applicable to the operations described with reference to FIG. 7, and thus a more detailed and repeated description will be omitted here for brevity.

According to example embodiments, by selecting a sequence in which output information is to be allocated to a plurality of pixels using a relatively prime number of a number of pieces of output information to be allocated to the pixels, light to be radiated from a display panel may be equally distributed, and thus a quality of a 3D image may be improved.

According to example embodiments, using a relatively prime number of a number of pieces of output information, a simple increment or decrement of direction angles or viewpoints may be prevented. By designing with mixed direction angles or viewpoints, an optimal sequence through which light radiated from a display panel is equally distributed may be readily discovered.

According to example embodiments, by calculating a sequence using a relatively prime number of a number of pieces of output information, a display apparatus may be designed to express all direction angles or viewpoints equally.

According to example embodiments, by selecting, from sequences determined using a relatively prime number of a number of pieces of output information, a sequence corresponding to a minimum distance having a greatest value among minimum distances between grating elements, a width of each of the grating elements may be maximized. Thus, degradation of brightness, or an increase in diffraction or crosstalk that may occur in a grating layer may be prevented effectively.

According to example embodiments, by determining a sequence in which output information is to be allocated to a display panel and determining a width of a grating element (or a distance between grating elements), a display apparatus may be designed using a design parameter verified in a parallax barrier, a lenticular lens, and the like.

The above-described example embodiments may be recorded in non-transitory computer-readable media including program instructions to implement various operations that may be performed by a computer or hardware processor. The media may also include, alone or in combination with the program instructions, data files, data structures, and the like. The program instructions recorded on the media may be those specially designed and constructed for the purposes of the example embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter. The described hardware devices may be configured to act as one or more software modules to perform the operations of the above-described example embodiments, or vice versa.

The foregoing example embodiments are examples and are not to be construed as limiting. The present teaching can be readily applied to other types of apparatuses. Also, the description of the example embodiments is intended to be illustrative, and not to limit the scope of the claims, and many alternatives, modifications, and variations will be apparent to those skilled in the art.

What is claimed is:

1. A display apparatus comprising:
a display panel comprising a plurality of pixels to which a plurality of pieces of output information for outputting a three-dimensional (3D) image is allocated according to a sequence; and
a grating layer comprising a plurality of grating elements configured to transfer, to the plurality of pixels, directional light according to the sequence,
wherein the sequence is determined so that a distance between pieces of output information allocated to neighboring pixels among the plurality of pixels corresponds to a relatively prime number of a number of the plurality of pieces of output information allocated to the plurality of pixels.

2. The display apparatus of claim 1, wherein the plurality of grating elements is arranged in the grating layer so that light refracted while penetrating through an optical film disposed between the display panel and the grating layer has directivity according to the sequence in the grating layer.

3. The display apparatus of claim 1, wherein a width of each of the plurality of grating elements is a minimum distance between neighboring grating elements in the grating layer.

4. The display apparatus of claim 1, wherein a width of each of the plurality of grating elements is a maximum value in a range in which the plurality of grating elements in the grating layer do not overlap each other.

5. The display apparatus of claim 1, wherein, in response to a plurality of relatively prime numbers of the number of the pieces of output information existing, the sequence is determined by determining a sequence corresponding to each of the relatively prime numbers based on a corresponding relatively prime number, verifying minimum distances between neighboring grating elements among the plurality of grating elements corresponding to each of the sequences, and selecting a sequence corresponding to a minimum distance having a greatest value among the verified minimum distances.

6. The display apparatus of claim 5, wherein a location of each of the plurality of grating elements is determined based on a corresponding sequence, and
a minimum distance between neighboring grating elements among the plurality of grating elements is determined based on the location of each of the plurality of grating elements determined according to a corresponding sequence.

7. The display apparatus of claim 1, wherein the 3D image comprises a multiview image represented by multiple viewpoints, and
the output information comprises a viewpoint to be represented in a corresponding pixel among the multiple viewpoints represented in the multiview image.

8. The display apparatus of claim 1, wherein the 3D image comprises an integral image embodying the 3D image by integrating elemental images including 3D information of a target object into the 3D image, and
the output information comprises a direction angle at which light is to be radiated from a corresponding pixel among a plurality of direction angles represented in the integral image.

9. The display apparatus of claim 8, wherein the sequence is determined so that a distance between direction angles allocated to the neighboring pixels among the plurality of pixels is determined by a relatively prime number of a number of the direction angles represented in the integral image and a minimum angle difference among the direction angles represented in the integral image.

10. A method of designing a display apparatus comprising a display panel and a grating layer, the method comprising:
determining a relatively prime number of a number of pieces of output information to output a three-dimensional (3D) image through a plurality of pixels included in the display panel;
determining a sequence in which the output information is to be allocated to the plurality of pixels based on the relatively prime number;
determining a location of each of a plurality of grating elements included in the grating layer to transfer, to the plurality of pixels, directional light according to the sequence;
verifying a minimum distance between neighboring grating elements among the plurality of grating elements; and
in response to a plurality of relatively prime numbers of the number of the pieces of output information existing, allocating the output information to the plurality of pixels based on a selected sequence corresponding to a minimum distance having a greatest value among minimum distances corresponding respectively to the plurality of relatively prime numbers.

11. The method of claim 10, wherein the determining of the location of each of the plurality of grating elements comprises:
determining the location of each of the plurality of grating elements so that light refracted while penetrating through an optical film disposed between the display panel and the grating layer has directivity according to the sequence in the plurality of pixels.

12. The method of claim 10, wherein a width of each of the plurality of grating elements corresponding to the selected sequence is determined by a minimum distance between the neighboring grating elements among the plurality of grating elements arranged based on the selected sequence.

13. The method of claim 10, wherein a width of each of a plurality of grating elements corresponding to the selected sequence is determined as a greatest value in a range in which the plurality of grating elements arranged based on the selected sequence do not overlap each other.

14. The method of claim 10, wherein the 3D image comprises a multiview image represented by multiple viewpoints, and
the output information comprises a viewpoint to be represented by a corresponding pixel among the multiple viewpoints represented in the multiview image.

15. The method of claim 10, wherein the 3D image comprises an integral image embodying the 3D image by integrating elemental images including 3D information of a target object, and
the output information comprises a direction angle at which light is to be radiated from a corresponding pixel among a plurality of direction angles represented in the integral image.

16. The method of claim 15, wherein the sequence is determined so that a distance between direction angles allocated to the neighboring pixels among the plurality of pixels is determined by a relatively prime number of a number of the direction angles represented in the integral image and a minimum angle difference among the plurality of direction angles represented in the integral image.

17. A non-transitory computer-readable storage medium storing a program that is executed by a computer to perform a method of designing a display apparatus comprising a display panel and a grating layer, the method comprising:
determining a relatively prime number of a number of pieces of output information to output a three-dimensional (3D) image through a plurality of pixels included in the display panel;
determining a sequence in which the output information is to be allocated to the plurality of pixels based on the relatively prime number;
determining a location of each of a plurality of grating elements included in the grating layer to transfer, to the plurality of pixels, directional light according to the sequence;
verifying a minimum distance between neighboring grating elements among the plurality of grating elements; and
in response to a plurality of relatively prime numbers of the number of the pieces of output information existing, allocating the output information to the plurality of pixels based on a selected sequence corresponding to a minimum distance having a greatest value among minimum distances corresponding respectively to the plurality of relatively prime numbers.
